(19) United States
(12) Patent Application Publication
(10) Pub. No.: US 2013/0342838 A1
(43) Pub. Date: Dec. 26, 2013

(54) OPTICAL PARTICLE DETECTING DEVICE AND PARTICLE DETECTING METHOD

(71) Applicant: Azbil Corporation, Tokyo (JP)

(72) Inventor: Seiichiro KINUGASA, Tokyo (JP)

(21) Appl. No.: 13/924,063

(22) Filed: Jun. 21, 2013

(30) Foreign Application Priority Data
Jun. 22, 2012 (JP) 2012-140854

(51) Int. Cl. G01N 15/14

(52) U.S. Cl. CPC G01N 15/1434
USPC 356/338; 250/458.1; 250/459.1

(57) ABSTRACT

An optical particle detecting device including a light source that emits an inspection light, a converting unit that converts the inspection light into collimated light, a focusing reflecting mirror that reflects toward a focal point the inspection light that has been converted into collimated light, a jet mechanism that causes an airstream including a particle to jet into the focal point of the focusing reflecting mirror, and a detecting portion that detects either scattered light or fluorescence produced by the particle included in the airstream being illuminated by the inspection light.

### CROSS REFERENCE TO RELATED APPLICATION

The present application claims priority under 35 U.S.C. §119 to Japanese Patent Application No. 2012-140854, filed Jun. 22, 2012, which is incorporated herein by reference in its entirety.

### FIELD OF TECHNOLOGY

The present invention relates to an environment evaluating technology, and, in particular, relates to an optical particle detecting device and particle detecting method.

### BACKGROUND

In clean rooms, such as bio clean rooms, airborne particles are detected and recorded using particle detecting devices. See, for example, Japanese Examined Patent Application Publications 2000-500867, 2008-32659 and 2011-21948, and also Norio Hasegawa, et al., “Instantaneous Bioaerosol Detection Technology and Its Application,” Yamatake Corporation, Azbil Technical Review, December 2009, Pages 2-7, 2009.

The state of wear of the air-conditioning equipment of the clean room can be ascertained from the result of the particle detection. Moreover, a record of particle detection within the clean room may be added as reference documentation to the products manufactured within the clean MOM.

Optical particle detecting devices draw in air from a clean room, for example, and illuminate the drawn-in air with an excitation beam. When there is a particle included within the air, the particle that is illuminated with the excitation beam produces fluorescence or intrinsic fluorescence (where, in the below, “fluorescence” and “intrinsic fluorescence” shall be referred to together as “fluorescence”). The wavelength and intensity of the fluorescence produced by the particle will vary depending on the type of particle. Consequently, it is possible to identify the type of particle that is airborne within the clean room through observing the wavelength and intensity of the fluorescence produced by the particle.

Moreover, an optical particle detecting device is able to identify the concentration and sizes of particles, and the like, through analyzing scattered light produced by illuminating particles with light.

In particle detecting devices, the wavelengths of light with which particles are illuminated may be varied. Given this, an aspect of the present invention is to provide an optical particle detecting device and particle detecting method compatible with variations in the wavelengths of the light with which the particles are illuminated.

### SUMMARY

A form of the present invention provides an optical particle detecting device including a light source that emits an inspection light, a converting unit that converts the inspection light into collimated light, a focusing reflecting mirror that reflects toward a focal point the inspection light that has been converted into collimated light, a jet mechanism that causes an airstream including a particle to jet into the focal point of the focusing reflecting mirror, and a detecting portion that detects scattered light or fluorescence produced by the particle included in the airstream being illuminated by the inspection light.

Moreover, a form of the present invention provides a particle detecting method that includes the steps of emitting an inspection light, converting, by converting unit, the inspection light into collimated light, reflecting, by a focusing reflecting mirror having a focal point, the inspection light that has been converted into collimated light toward a focal point, jetting an airstream including a particle into the focal point of the focusing reflecting mirror, and detecting scattered light or fluorescence produced by the particle included in the airstream being illuminated by the inspection light.

The present invention is able to provide an optical particle detecting device and particle detecting method compatible with variations in the wavelengths of the light with which the particles are illuminated.

### BRIEF DESCRIPTION OF THE DRAWINGS

FIG. 1 is a schematic diagram of an optical particle detecting device as set forth in an example according to the present invention.

FIG. 2 is a schematic diagram of an optical particle detecting device as set forth in the example according to the present invention.

FIG. 3 is a schematic diagram of an optical particle detecting device as set forth in another example according to the present invention.

FIG. 4 is a schematic diagram of an optical particle detecting device as set forth in the another example according to the present invention.

### DETAILED DESCRIPTION

Examples of the present invention will be described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

### EXAMPLE

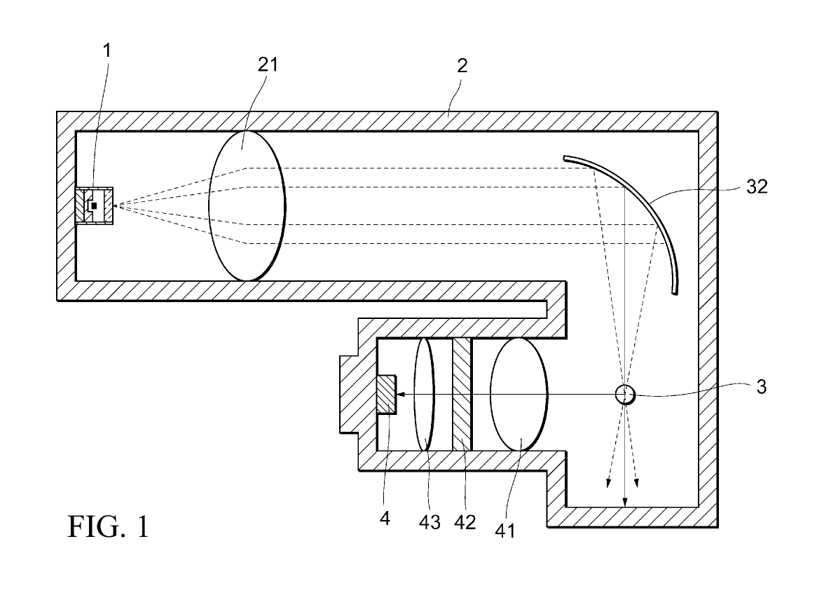

An optical particle detecting device according to an example, as illustrated in FIG. 1, includes a light source 1 that emits an inspection light, a converting unit 21 that converts the inspection light into collimated light, a focusing reflecting mirror 31, having a focal point, which reflects toward the focal point the excitation beam that has been converted into collimated light, a jet mechanism 3 that causes an airstream including a particle to jet into the focal point of the focusing reflecting mirror 31, and a light detecting portion 4 that detects fluorescence produced by the particle included in the airstream being illuminated by the excitation beam. Here particles include microbes, non-toxic or toxic chemical substances, and dust such as dirt, grime, etc.

A light-emitting diode (LED), for example, may be used as the light source 1, although there is no limitation thereto. The excitation beam that is emitted from the light source 1 may be visible light or may be ultraviolet light. In the case of the excitation beam being visible light, the wavelength of the excitation beam is in the range of for example, between 400 and 410 nm, for example, 405 nm. In the case of the excitation beam being ultraviolet light, the wavelength of the excitation beam is in the range of for example, between 310 and 380 nm, for example, 355 nm. A controller for setting the intensity and wavelength of the excitation beam emitted by the light source 1, and a power supply device for supplying a power supply electric current to the light source 1, are connected to the light source 1.

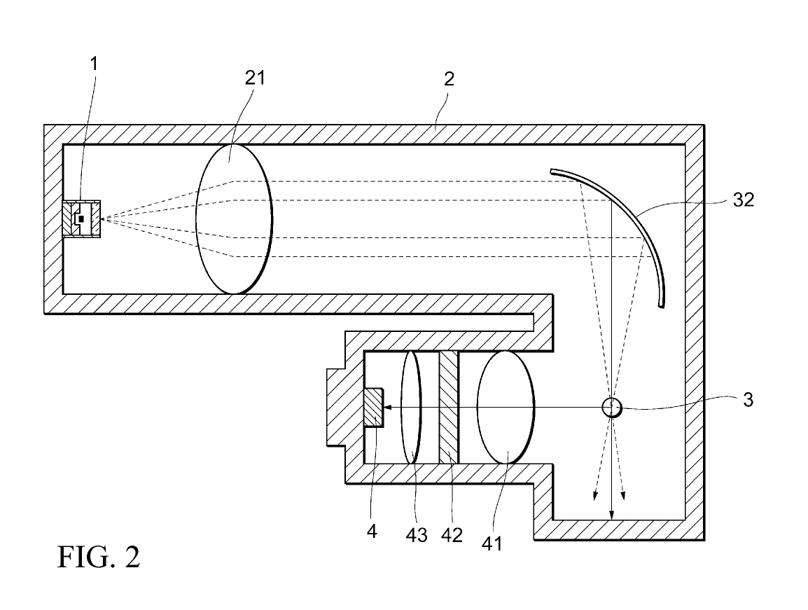

The converting unit 21 is disposed, for example, relative to the light source 1. The converting unit 21 is a collimating lens able to convert into a collimated beam scattered light or emitted light, for example. The focusing reflecting mirror 31 is disposed on the optical axis of the converting unit 21 that is a collimating lens, paired with the converting unit 21. The focusing reflecting mirror 31 may use a parabolic mirror, or a spherical mirror that has a constant radius of curvature. Additionally, as illustrated in FIG. 2, an off-axis parabolic mirror or off-axis spherical mirror may be used as a focusing reflecting mirror 32. The focusing reflecting mirrors 31 and 32 are manufactured through coating polished glass with a metal such as aluminum (Al) or gold (Au). Conversely, the focusing reflecting mirrors 31 and 32 are manufactured through mechanically processing a metal material such as aluminum or stainless steel using a diamond scribe.

The light source 1, the converting unit 21, and the focusing reflecting mirror 31, illustrated in FIG. 1, are disposed within a case 2. The excitation light that is emitted from the light source 1 is converted into a collimated beam by the converting unit 21 and is incident on the focusing reflecting mirror 31. The excitation light is reflected by the focusing reflecting mirror 31 to be focused on the focal point of the focusing reflecting mirror 31.

The jet mechanism 3 draws in air from the outside of the case 2, using a fan, or the like, and then emits, through a nozzle, or the like, a jet of the air that has been drawn in in the direction of the focal point of the focusing reflecting mirror 31. The direction in which the airstream that is jetted from the jet mechanism 3 advances is set to, for example, essentially perpendicular relative to the optical axis of the focusing reflecting mirror 31. If a particle is included in the air flow here, then the particle that is illuminated by the excitation light will produce fluorescence. For example, when microorganisms, such as microbes, or the like, exist within the air, then the tryptophan, nicotinamide adenine dinucleotide, and riboflavin, and the like within the microbes will be exposed to the excitation light, to produce fluorescence.

Examples of such microbes include Gram-negative bacteria, Gram-positive bacteria, and fungi such as mold spores. Escherichia coli, for example, can be listed as an example of a Gram-negative bacterium. Staphylococcus epidermidis, Bacillus atrophaeus, Micrococcus lylae, and Corynebacterium afermentans can be listed as examples of Gram-positive bacteria. Aspergillus niger can be listed as an example of a fungus such as a mold spore. The airstream the cuts across the light that is focused by the focusing reflecting mirror 31 is exhausted to the outside of the case 2 by an exhausting mechanism.

Furthermore, a detecting system collimating lens 41, for collimating the fluorescence produced by the particles, and a detecting system focusing lens 43, for focusing in the direction of the light detecting portion 4 the fluorescence that has been collimated by the detecting system collimating lens 41, are disposed within the case 2 between the focal point of the focusing reflecting mirror 31 and the detecting light portion 4. The detecting system collimating lens 41 is, for example, disposed so that the optical axis thereof passes through the focal point of the focusing reflecting mirror 31. A wavelength selecting element 42 that allows only a specific fluorescence to pass therethrough may be provided between the detecting system collimating lens 41 and the detecting system focusing lens 43. A band pass filter, such as a low-pass filter, may be used as the wavelength selecting element 42. The detecting light portion 4 may use, for example, a photodiode, a photoelectron multiplier tube, or the like. A computer for performing statistical processes on the florescent light intensities that are detected, for example, is connected to the light detecting portion 4.

In the optical particle detecting device according to the example, set forth above, the excitation light that is incident on to the focusing reflecting mirror 31 is focused onto the focal point of the focusing reflecting mirror 31 without chromatic aberration. Because of this, even if the wavelength of the excitation light is varied depending on the particle that is to be detected, there will be no need to change the optics system, aside from the light source 1 for the excitation light, and no need to change the flow path of the airflow in which the particles may be included. Consequently, it is possible to detect and identify particles of many different types at a low cost.

Moreover, the converting unit 21, which is a collimating lens, the detecting system collimating lens 41, and/or the detecting system focusing lens 43 may be an achromatic lens. The achromatic lens is structured through a combination of two or more lenses having different indices of refraction and different optical dispersion (Abbé numbers). For example, an achromatic lens is structured from a combination of a convex lens of crown glass and a concave lens of flint glass. The converting unit 21, which is a collimating lens, the detecting system collimating lens 41, and/or the detecting system focusing lens 43 being be an achromatic lens can further compensate for chromatic aberration.

### Another Example

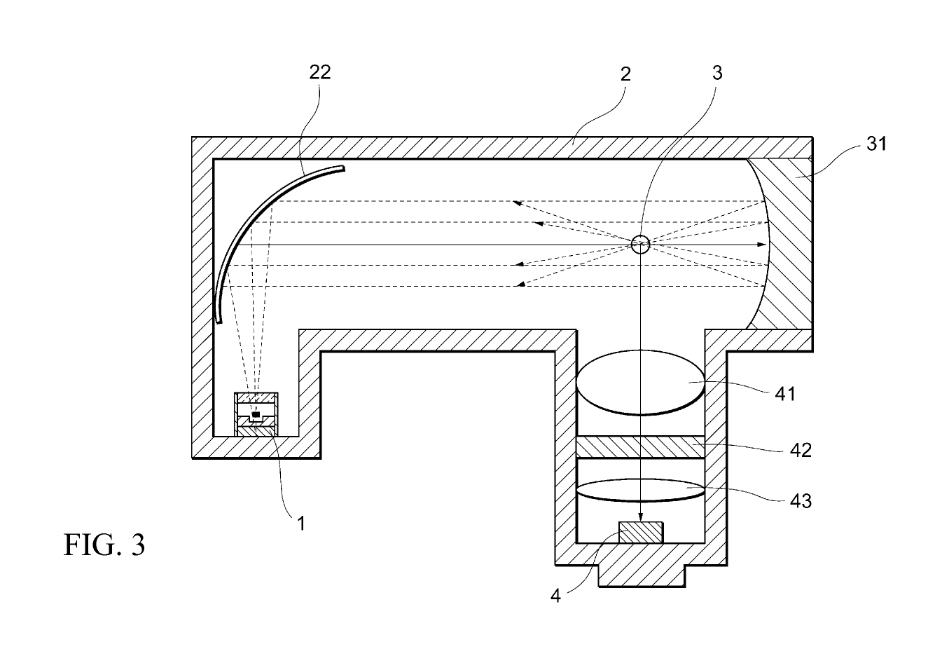

An optical particle detecting device according to another example, as illustrated in FIG. 3, uses a concave mirror that is an off-axis parabolic mirror or off-axis spherical mirror in the converting unit 22. When the excitation light is ultraviolet radiation, if the converting unit 22 were to be a lens, there would be a problem with low transmissivity. Moreover, the lens itself may produce fluorescence. When, in response to this, an off-axis parabolic mirror or an off-axis spherical mirror is used in the converting unit 22, there is no such problem with the reduction in transmissivity of the ultraviolet radiation, nor with the production of fluorescence from the lens, that would occur when using a lens.

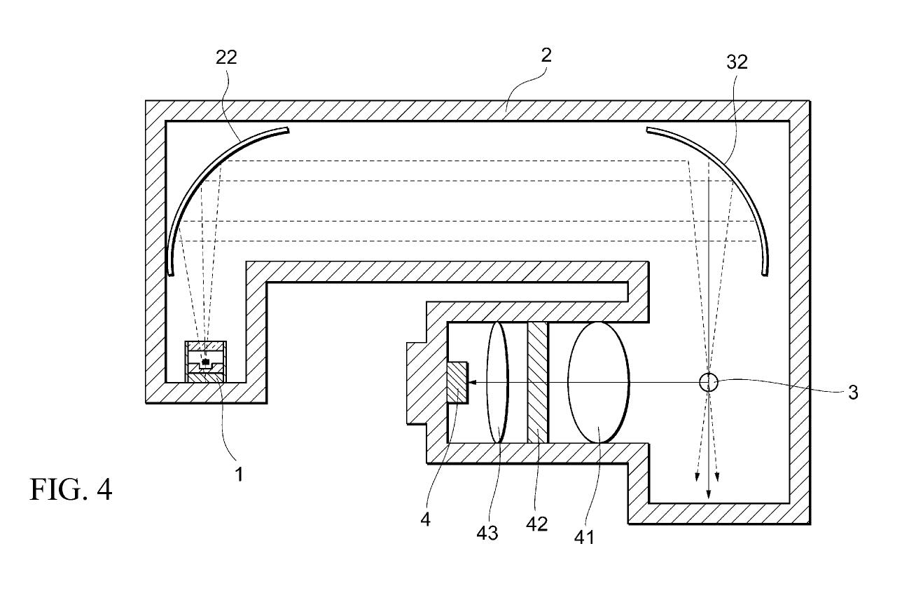

In the another example as well, the focusing reflecting mirror 31 may use a parabolic mirror, or a spherical mirror that has a constant radius of curvature. Conversely, as illustrated in FIG. 4, an off-axis parabolic mirror or an off-axis spherical mirror may be used as a focusing reflecting mirror 32. The other structural elements in the optical particle detecting device according to the another example are identical to those in the example.

### Other Examples

While the above descriptions provides the examples as set forth above, the descriptions and drawings that form a portion of the disclosure are not to be understood to limit the present invention. A variety of alternate examples and operating technologies should be obvious to those skilled in the art. For example, in the example and the another example, particles are illuminated with excitation light as the inspection light, and fluorescence is detected. In contrast, scattered light that is produced by illumination of the particles with the inspection light may be collimated by the detecting system collimating lens 41 and the collimated light deriving from the scattered light may be focused toward the light detecting portion 4 by the detecting system focusing lens 43. The strength of the light that is scattered by a particle is correlated with the size of the particle. Consequently, detecting the intensity of the light deriving from the scattered light using the light detecting portion 4 makes it possible to calculate the size of the airborne particles in the environment wherein the optical particle detecting device is placed. In this way, the present invention should be understood to include a variety of examples, and the like, not set forth herein.

1: An optical particle detecting device comprising:
a light source that emits an inspection light;
a converting unit that converts the inspection light into collimated light;
a focusing reflecting mirror that reflects toward a focal point the inspection light that has been converted into collimated light;
a jet mechanism that causes an airstream including a particle to jet into the focal point of the focusing reflecting mirror; and
a detecting portion that detects either scattered light or fluorescence produced by the particle included in the airstream being illuminated by the inspection light.

2: The optical particle detecting device as set forth in claim 1, wherein the focusing reflecting mirror is a parabolic mirror.

3: The optical particle detecting device as set forth in claim 1, further comprising:
an achromatic lens disposed between the focal point of the focusing reflecting mirror and the light detecting portion.

4: The optical particle detecting device as set forth in claim 1, wherein the converting unit is a collimating lens.

5: The optical particle detecting device as set forth in claim 1, wherein the converting unit is a concave mirror.

6: The optical particle detecting device as set forth in claim 5, wherein the concave mirror is an off-axis parabolic mirror.

7: The optical particle detecting device as set forth in claim 5, wherein the concave mirror is an off-axis spherical mirror.

8: The optical particle detecting device as set forth in claim 1, wherein the light source is a light-emitting diode.

9: A particle detecting method, comprising:
emitting an inspection light;
converting, by a converting unit, the inspection light into collimated light;
reflecting, by a focusing reflecting mirror having a focal point, the inspection light that has been converted into collimated light toward a focal point;
jetting an airstream including a particle into the focal point of the focusing reflecting mirror; and
detecting scattered light or fluorescence produced by the particle included in the airstream being illuminated by the inspection light.

10: The particle detecting method as set forth in claim 9, wherein the focusing reflecting mirror is a parabolic mirror.

11: The particle detecting method as set forth in claim 9, wherein
the detection of scattered light or fluorescence includes having the scattered light or fluorescence to be incident into an achromatic lens.

12: The particle detecting method as set forth in claim 9, wherein the converting unit is a collimating lens.

13: The particle detecting method as set forth in claim 9, wherein the converting unit is a concave mirror.

14: The particle detecting method as set forth in claim 13, wherein the concave mirror is an off-axis parabolic mirror.

15: The particle detecting method as set forth in claim 13, wherein the concave mirror is an off-axis spherical mirror.

16: The particle detecting method as set forth in claim 9, wherein the inspection light is emitted from a light-emitting diode.
